(19) United States
(12) Patent Application Publication
(10) Pub. No.: US 2013/0163575 A1
(43) Pub. Date: Jun. 27, 2013

(54) CONTENTION BASED CHANNEL OCCUPYING METHOD IN WIRELESS NETWORK USING A PLURALITY OF CHANNELS

(71) Applicant: ELECTRONICS AND TELECOMMUNICATIONS RESEARCH INSTITUTE, Daejeon (KR)

(72) Inventors: Jin Suk PAK, Daejeon (KR); Jung Sun UM, Daejeon (KR); Gwang Zeen KO, Daejeon (KR); Sung Jin YOO, Daejeon (KR); Sang Won KIM, Daejeon (KR); Byung Jang JEONG, Daejeon (KR)

(73) Assignee: ELECTRONICS AND TELECOMMUNICATIONS RESEARCH INSTITUTE, Daejeon (KR)

(21) Appl. No.: 13/627,319

(22) Filed: Sep. 26, 2012

(30) Foreign Application Priority Data
Dec. 26, 2011 (KR) 10-2011-0142026

(51) Int. Cl. H04W 84/12; H04L 12/413

(52) U.S. Cl. 370/338; 370/445

(57) ABSTRACT

Disclosed is a contention based channel occupying method in a wireless network using a plurality of channels, including: acquiring, by terminals that are incapable of transmitting a data frame through primary contention, occupation channel information from a terminal that transmits the data frame through the primary contention; verifying, by the terminals, an occupiable channel based on the occupation channel information; and performing, by the terminals, secondary contention in the occupiable channel.

### CROSS-REFERENCE TO RELATED APPLICATIONS

This application claims priority to and the benefit of Korean Patent Application No. 10-2011-0142026 filed in the Korean Intellectual Property Office on Dec. 26, 2011, the entire contents of which are incorporated herein by reference.

### TECHNICAL FIELD

The present invention relates to a contention based channel occupying method in a wireless network using a plurality of channels, and more particularly, to a contention based channel occupying method in an environment of a wireless network in which a plurality of terminals occupy channels based on contention, and combine and use the plurality of channels.

### BACKGROUND ART

In general, only when a wireless device in a wireless network uses a usable wireless channel, the wireless device can transmit/receive data. A wireless channel occupying method is divided into a contention based scheme in which the wireless devices occupy the wireless channel through contention and a resource allocation scheme in which a resource manager grants a channel occupying authority to the wireless devices. Representative examples of the contention based scheme include a carrier sense multiple access/collision detect (CSMA/CD) protocol and a carrier sense multiple access/collision avoidance (CSMA/CA) protocol.

Meanwhile, as the amount of data transferred through the wireless network increases, a method of combining and using the plurality of channels in order to extend a transmission bandwidth is proposed. The method of combining the plurality of channels includes channel bonding combining neighboring channels and using the combined channels as one transmission channel and channel aggregation combining non-neighboring channels and using the combined channels as one transmission channel.

In the resource allocation scheme, the resource manager manages a channel which each wireless device will occupy and a time for each channel and each time unit, respectively, and transfers the information to the wireless devices. Each wireless device transmits/receives data according to information allocated to the wireless device itself. In the resource allocation scheme, the wireless devices allocate the channel to each wireless device to minimize waste of a channel resource according to various channel requirements of the wireless devices.

However, in the contention based scheme of occupying the plurality of channels, it is difficult to effectively use the plurality of channels. When the wireless device has a plurality of transmission/reception routes through a plurality of antennas, the respectively channels are used through several transmission/reception routes, but small-sized wireless terminals such as a notebook, a cellular phone, WiBro or WiFi dongle cannot but have a limited number of transmission/reception routes. Therefore, when the neighboring channels not combined and used, but the non-neighboring channels intend to be combined and used, combinable channels are limited due to limitation of the transmission/reception routes.

### SUMMARY OF THE INVENTION

The present invention has been made in an effort to provide a contention based channel occupying method that can increase efficiency in occupying a channel under a wireless network environment in which a plurality of terminals can occupy the channel based on contention, and combine and use a plurality of channels.

An exemplary embodiment of the present invention provides a contention based channel occupying method in a wireless network using a plurality of channels, including: acquiring, by terminals that are incapable of transmitting a data frame through primary contention, occupation channel information from a terminal that transmits the data frame through the primary contention; verifying, by the terminals, an occupiable channel based on the occupation channel information; and performing, by the terminals, secondary contention in the occupiable channel.

In the acquiring of the occupation channel information, the terminals may acquire channel occupation duration information from the terminal that transmits the data frame, and the terminal that transmits the data frame through the secondary contention among the terminals set its own channel occupation duration to coincide with a termination time of a channel occupation duration of the terminal.

The terminal that transmits the data frame through the secondary contention makes the set channel occupation duration information be included in the data frame.

In the performing of the secondary contention, the terminals may start the secondary contention when the data frame is transmitted through the primary contention.

In the performing of the secondary contention, each of the terminals set predetermined secondary contention allowance time, and when the secondary contention allowance time has been exceeded, each terminal does not perform the secondary contention any more.

A back-off unit time of a back-off process for the secondary contention may be shorter than a back-off unit time of a back-off process for the primary contention.

The size of a contention window of the back-off process for the secondary contention may be smaller than the size of the contention window of the back-off process for the primary contention.

The terminal that transmits the data frame through the secondary contention among the terminals may transmit a signal to notify channel occupation before transmitting the data frame.

Another exemplary embodiment of the present invention provides a contention based channel occupying method in a wireless LAN environment using a plurality of channels, including: acquiring, by terminals that are incapable of transmitting a data frame through primary contention, occupation channel information and a network allocation vector (NAV) from a terminal that transmits the data frame through the primary contention; verifying, by the terminals, an occupiable channel based on the occupation channel information; performing, by the terminals, secondary contention in the occupiable channel; and setting, by a terminal that transmits the data frame, its own NAV to coincide with a termination time of the acquired NAV in accordance with the result of the secondary contention and transmitting the data frame including the set NAV.

The primary contention or secondary contention may include back-off, clear channel assessment (CCA), request to send (RTS), and clear to send (CTS).

The primary contention or secondary contention may include the back-off and the clear channel assessment (CCA).

In the acquiring of the occupation channel information and the NAV, the NAV may be extracted from a frame header of the data frame transmitted from the terminal.

A slot time of a contention window of the back-off process for the secondary contention may be shorter than the slot time of the contention window of the back-off process for the primary contention.

The number of slots of the contention window of the back-off process for the secondary contention may be shorter than the number of slots of the contention window of the back-off process for the primary contention.

When the secondary contention includes the back-off and the clear channel assessment (CCA), not the request to send (RTS) and the clear to send (CTS), the terminal that transmits the data frame through the secondary contention may transmit a signal to notify channel occupation before transmitting the data frame.

According to the exemplary embodiments of the present invention, the efficiency in occupying the channel can be increased under the wireless network environment in which the plurality of terminals can occupy the channel based on the contention, and combine and use the plurality of channels.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates a network environment for describing exemplary embodiments of the present invention.

FIG. 2 illustrates one example of a format in which a plurality of terminals occupies channels based on contention in a wireless network using a plurality of channels in order to assist understanding the present invention.

FIG. 3 illustrates another example of a format in which a plurality of terminals occupies channels based on contention in a wireless network using a plurality of channels in order to assist understanding the present invention.

FIG. 4 illustrates yet another example of a format in which a plurality of terminals occupies channels based on contention in a wireless network using a plurality of channels in order to assist understanding the present invention.

FIG. 5 is a flowchart illustrating a contention based channel occupying method according to an exemplary embodiment of the present invention.

FIG. 6 illustrates one example of a format in which a plurality of terminals occupies channels according to at least one exemplary embodiment of the present invention.

FIG. 7 illustrates another example of a format in which a plurality of terminals occupies channels according to at least one exemplary embodiment of the present invention.

FIG. 8 illustrates yet another example of a format in which a plurality of terminals occupies channels according to at least one exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

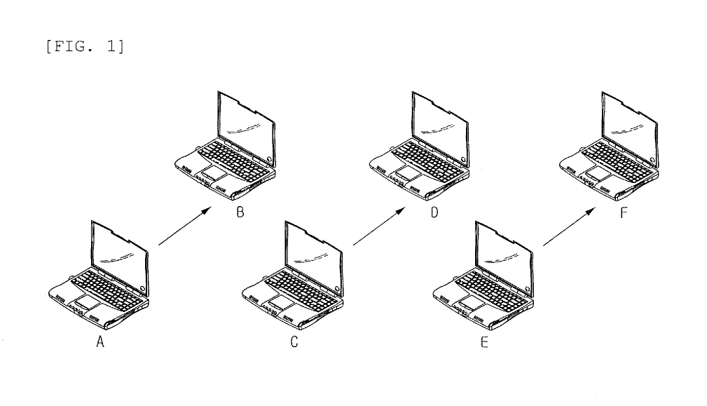

FIG. 1 illustrates a network environment for describing exemplary embodiments of the present invention. The network environment of FIG. 1 may have a master-slave structure in which an access point (AP) is present and an Ad-hoc structure in which the AP is not present, although not illustrated. In the network environment of FIG. 1, terminals may combine and use a plurality of channels and in some cases, may combine and use the channels in a method of channel bonding or channel aggregation. However, channels which some terminals may combine may be limited due to limitation of transmission/reception routes, and some terminals may be terminals that may not combine the plurality of channels but uses only a single terminal.

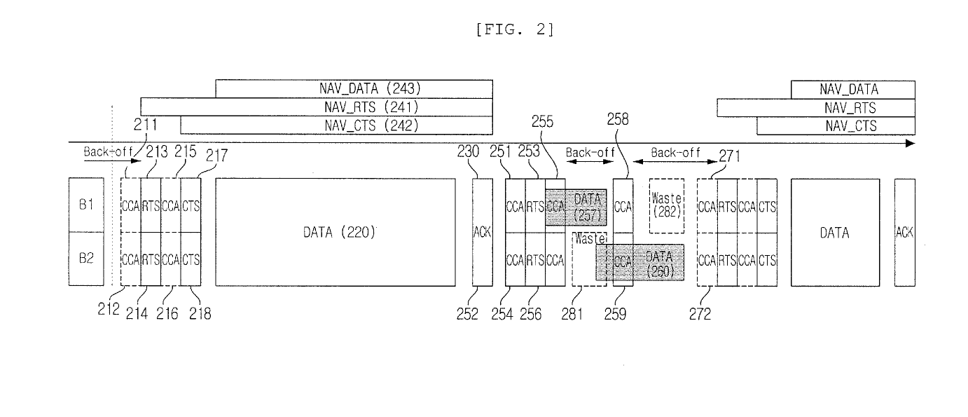

Referring to FIG. 1, a terminal A intends to transmit data to a terminal B, a terminal C intends to transmit data to a terminal D, and a terminal E intends to transmit data to a terminal F. Hereinafter, FIG. 1 will be referred together in describing in FIGS. 2 to 4 and FIGS. 6 to 8.

FIG. 2 illustrates one example of a format in which a plurality of terminals occupies channels based on contention in a wireless network using a plurality of channels in order to assist understanding the present invention. In the example, the terminal A intends to combine combinable channels and transmit data to the terminal B.

Referring to FIG. 2, a channel B1 and a channel B2 are illustrated. The terminal A verifies whether the channels B1 and B2 are in an idle state by performing a back-off process and clear channel assessment (CCA) 211 and 212 for the channels B1 and B2. When data intend to be transmitted through the plurality of channels, it needs to be verified whether the corresponding channel is in the idle state by performing CCA with each channel. It is verified that both the channels B1 and B2 are in the idle state, such that the terminal A transmits request to send (RTS) frames 213 and 214 to the terminal B. The terminal B that receives the RTS frames 213 and 214 also verify whether the corresponding channel is in the idle state by performing CCA 215 and 216 with respect to the channels B1 and B2. When it is verified that both the channels B1 and B2 are in the idle state, the terminal B transmits clear to send (CTS) frames 217 and 218 to the terminal A. The terminal A that receives the CTS frames 217 and 218 transmits a data frame 220 to the terminal B. The terminal B transmits an ACK frame 230 to the terminal A when reception of the data frame 220 is completed.

The terminal makes information on a channel occupation duration which a duration until transmission/reception of the data frame to/from the RTS frame is completed be included in a frame header region, at the time of transmitting the RTS frame. For example, in an IEEE 802.11 wireless LAN standard, network allocation vector (NAV)_RTS included in the RTS frame is a transmission duration of the CTS frame, a transmission duration of the data frame, a transmission duration of the ACK frame, and a value acquired by adding 3 shot interframe space (SIFS) values required for transmitting the frames. The terminals that receive the RTS frame except for a destination terminal set a timer as long as a channel occupation period included in the RTS frame, and do not use the corresponding channel during the period.

The terminal makes the information on the channel occupation duration which is the duration until the transmission/reception of the data is completed be included in the frame header region even at the time of transmitting the CTS frame and at the time of transmitting the data frame. For example, in the IEEE 802.11 wireless LAN standard, NAV_CTS included in the CTS frame is a value acquired by subtracting an already consumed SIFS value and the transmission duration of the CTS frame from an NAV_RTS value acquired in the RTS frame. The terminals that receive the CTS frame except for a source terminal set a timer as long as a channel occupation period included in the CTS frame, and do not use the corresponding channel during the period.

Referring to FIG. 2, the terminal A sets NAV_RTS 241 through the RTS frames 213 and 214, the terminal B sets NAV_CTS 242 through the CTS frames 217 and 218, and the terminal A sets NAV_DATA 243 through the data frame 220.

When transmission of the data frame from the terminal A to the terminal B through the channels B1 and B2 is completed, the terminal A verifies whether the channels B1 and B2 are in the idle state by performing the CCA 251 and 252 in order to transmit the data frame through the channels B1 and B2 again. It is verified that both the channels B1 and B2 are in the idle state, such that the terminal A transmits the RTS frames 253 and 254 to the terminal B. The terminal B that receives the RTS frames 253 and 254 also verify whether the corresponding channel is in the idle state by performing the CCA 255 and 256 with respect to the channels B1 and B2. However, it is verified that the channel B1 is not in the idle state due to data 257 which has been already transmitted. Therefore, the terminal C performs the back-off process and the CCA 258 AND 259 for the channels B1 and B2 again. However, in this case, it is verified that the channel B is not in the idle state due to the data 260 which has been already transmitted. Therefore, the terminal C performs the back-off process and the CCA 271 and 272 for the channels B1 and B2 again. Since subsequent operations of the terminals A and B are the same as operations after the CCA 211 and 212 of the terminal A described above, a description thereof will be omitted.

Referring to FIG. 2, it is verified that the channel B1 is not in the idle state due to the data 257 which is transmitted in the channel B1, and as a result, although the channel B2 is in the idle state, waste 281, occurs, which is not used. It is verified that the channel B2 is not in the idle state due to the data 259 which is transmitted in the channel B2, and as a result, although the channel B1 is in the idle state, waste 282 which is not used occurs.

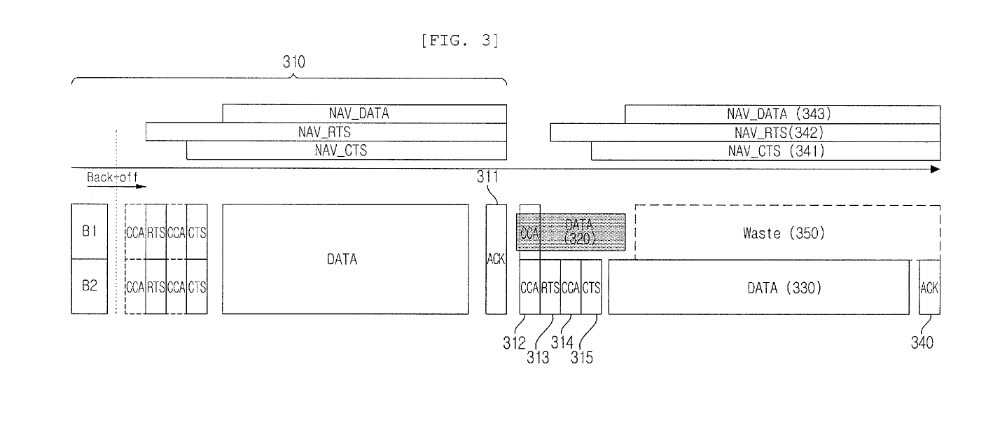

FIG. 3 illustrates another example of a format in which a plurality of terminals occupies channels based on contention in a wireless network using a plurality of channels in order to assist understanding the present invention. In this example, the terminal A basically intends to combine the combinable channels to transmit data to the terminal B, but when some channels among them have been already used, data may be transmitted by using only channels other than the corresponding channel.

Since a process corresponding to reference numeral 310 of FIG. 3 is the same as a process up to the ACK frame 230 in the description of FIG. 2, a description thereof will be omitted.

When transmission of the data frame from the terminal A to the terminal B through the channels B1 and B2 is completed, the terminal A verifies whether the channels B1 and B2 are in the idle state by performing CCA 311 and 312 in order to transmit the data frame through the channels B1 and B2 again. However, it is verified that the channel B1 is not in the idle state due to data 320 which has been already transmitted. However, it is verified that the channel B2 is in the idle state, such that the terminal A transmits an RTS frame 313 to the terminal B through the channel B2. The terminal B that receives the RTS frame 313 verifies whether the channel B2 is in the idle state by performing CCA 314 for the channel B2. When it is verified that the channel B2 is in the idle state, the terminal B transmits a CTS frame 315 to the terminal A. The terminal A that receives the CTS frame 315 transmits a data frame 330 to the terminal B. The terminal B transmits an ACK frame 340 to the terminal A when reception of the data frame 320 is completed.

Referring to FIG. 3, it is verified that the channel B1 is not in the idle state due to the data 320 which is transmitted in the channel B1, but after transmission of the data 320 is completed in the channel B1, which is in the idle state, waste 350 which is not used until channel occupation durations 341, 342, and 343 set by the terminals A and B are terminated occurs although the channel B1 is in the idle state.

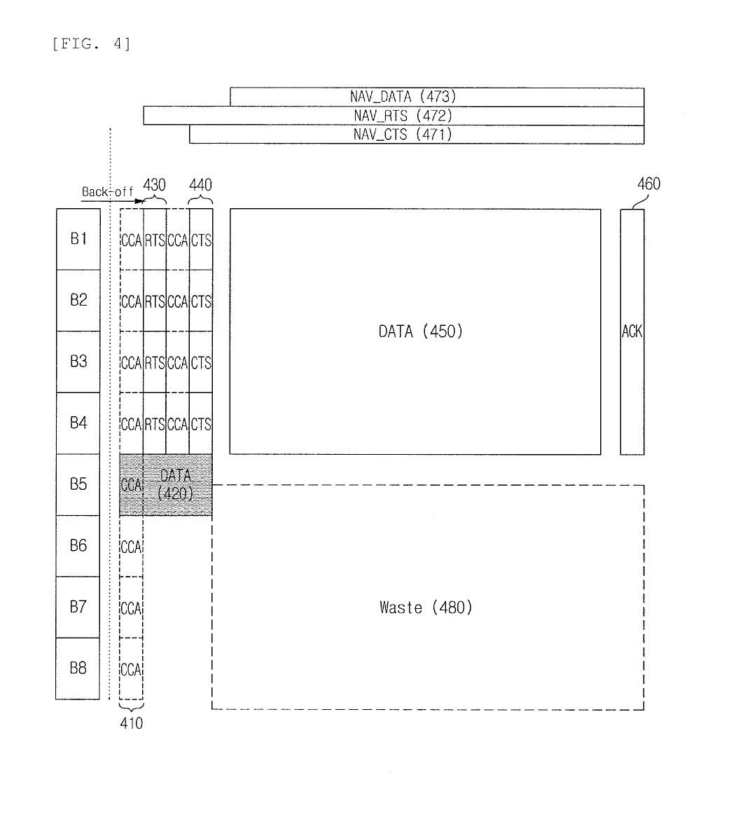

FIG. 4 illustrates yet another example of a format in which a plurality of terminals occupy channels based on contention in a wireless network using a plurality of channels in order to assist understanding the present invention. In this example, the terminal A also basically intends to combine the combinable channels to transmit data to the terminal B, but when some channels among them have been already used, data may be transmitted by using only remaining channels other than the corresponding channel.

Referring to FIG. 4, the channel B1 to a channel B8 are illustrated. The terminal A verifies whether the channels B1 to B8 are in the idle state by performing a back-off process and CCA 410 for the channels B1 to B8. Herein, it is verified that the channels B1 to B4 and the channels B6 to B8 are in the idle state, but it is verified that the channel B5 is not in the idle state due to data 420 which has been already transmitted. In this example, since the terminal A is a small-sized wireless terminal such as a notebook, a cellular phone, WiBro, or WiFi dongle, the terminal A has a limited number of transmission/reception routes. Therefore, the terminal A may not combine the channels B1 to B4 and the non-neighboring channels B6 to B8. As a result, the terminal A transmits an RTS frame 430 to the terminal B through the channels B1 to B4, receives a CTS frame 440 from the terminal B, transmits a data frame 450 to the terminal B, and receives an ACK frame 460 from the terminal B.

Referring to FIG. 4, it is verified that only the channel B5 is not in the idle state due to the data 420 which is transmitted in the channel B5, but after all, waste 480 which is not used until channel occupation durations 471, 472, and 473 set by the terminals A and B are terminated occurs although the channels B5 to B8 are all in the idle state.

As in the examples described above, in order to prevent the channel which is not used from being wasted, when any terminal transmits a data frame by using one or more channels through primary contention, terminals that do not transmit the data frame through the primary contention perform secondary contention again in a channel other than the channel to which the data frame is transmitted as a result of the primary contention. The terminal that transmits the data frame through the primary contention notifies a channel occupied by the terminal itself to other terminals, which may find the channel through which the data frame is transmitted as the result of the primary contention. For example, the terminal that transmits the data frame through the primary contention makes occupation channel information which is information indicating the channel occupied by the terminal itself be included in the frame header region of the data frame. When the terminals that do not transmit the data frame through the primary contention receive the data frame, channels through which the data frame is transmitted may be found. Of course, in the case in which any terminal (alternatively, terminals) occupies all channels through the primary contention, no channel to perform the secondary contention is provided, and as a result, the secondary contention is not performed.

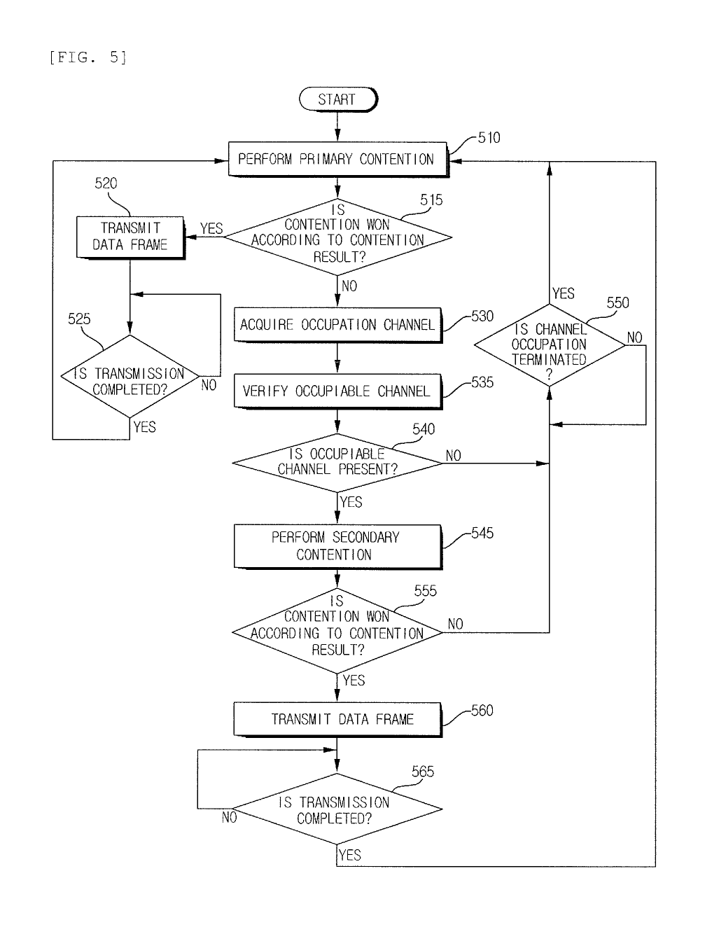

FIG. 5 is a flowchart illustrating a contention based channel occupying method according to an exemplary embodiment of the present invention. In the following description, ‘performing the contention’ means a process until the data frame is transmitted after the back-off process and the CCA are performed, the RTS frame is transmitted, and the CTS frame is received. However, transmission/reception of the RTS frame and the CTS frame may be omitted. For example, in the IEEE 802.11 wireless LAN standard, when the size of the data which the terminal intends to transmit is smaller than an RTS threshold value in MAC variables, the back-off process and the CCA are performed without an RTS/CTS process, and as a result, when it is verified that the channel is in the idle state, the data frame is immediately transmitted. In the exemplary embodiment, the RTS/CTS process may not performed if necessary although it is not such a case. In the following description, ‘performing the contention’ means even a process until the data frame is transmitted after the back-off process and the CCA are performed, the RTS frame is transmitted, and the CTS frame is received without performing the RTS/CTS process. According to the contention result, ‘winning’ means a case in which the CTS frame is received from the destination terminal to transmit the data frame to the destination terminal when the RTS/CTS process is performed and means that it is verified that the channel is in the idle state as the result of performing the back-off process and the CCA to transmit the data frame when the RTS/CTS process is not performed.

Referring to FIG. 5, first, terminals perform primary contention in a plurality of predetermined channels (510). In the primary contention, the terminal that performs the RTS/CTS process makes channel occupation duration information be included in the RTS frame and the CTS frame.

According to the result of the primary contention (515), the terminal that wins the primary contention transmits the data frame through one channel or two or more combined channels (520). In this case, the terminal makes occupation channel information and the channel occupation duration information be included in a frame header region of the data frame. The terminal returns to step 510 to perform the primary contention again when transmission is completed (that is, when an ACK frame is received) (525).

According to the result of the primary contention (515), terminals that are incapable of winning the contention acquire the occupation channel information from the terminal that wins the primary contention (530). The occupation channel information may be extracted from the frame header of the data frame which the winning terminal transmits.

The terminals that acquire the occupation channel information verify channels which the terminals themselves are capable of occupying based on the occupation channel information. In the case of an ideal case without a limit in the number of transmission/reception routes, the occupiable channels will be remaining channels other than the occupation channels of the terminal that wins in all channels. However, in general, since the terminal has a limit in the number of transmission/reception routes, the occupiable channels are decided according to the number of transmission/reception routes and the combination schemes (channel bonding and channel collection).

The terminals that verify the occupiable channels wait until occupation of the channels ends (550) if there is no occupiable channel (540) and when the occupation of the channel ends, the terminals return to step 510 to perform the contention.

The terminals that verify the occupiable channels perform the secondary contention in the occupiable channels (545) if there is the occupiable channel (540). A start time of the secondary contention may coincide with a transmission time of the data frame of the terminal that wins the primary contention. For example, a time to generate a contention window for the back-off process may coincide with the transmission time of the data frame of the terminal that wins the primary contention.

Since a channel occupation ending time of a terminal that will transmit data through secondary contention need not exceed a channel occupation ending time of a terminal that transmits data through the primary contention, terminals that participate in the secondary contention need to set individual secondary contention allowance time in advance. The terminals that participate in the secondary contention may acquire channel occupation duration information of the terminal that wins the primary contention. The terminal that participates in the secondary contention sets a secondary contention allowance time so as to prevent a time acquired by adding a time required to transmit the data frame and the secondary contention allowance time from being more than the channel occupation ending time of the terminal that wins the primary contention. The terminal that participates in the secondary contention does not participate in the second contention any more but waits until the occupation of the channel ends without participating in the secondary contention when the channel occupation ending time is more than the secondary contention allowance time after the secondary contention starts.

In the exemplary embodiment, the secondary contention is performed in the same manner as the primary contention. However, in another exemplary embodiment, the secondary contention may be performed in a manner a little different from the primary contention in order to reduce a time required for the secondary contention. This will be further described below.

According to the result of the secondary contention (555), the terminal that wins the primary contention transmits the data frame through one channel or two or more combined channels among the channels where the secondary contention is performed (560). The terminal that wins the secondary contention also makes the occupation channel information and the channel occupation duration information be included in the frame header region of the data frame.

The terminal that wins the secondary contention needs to complete transmission/reception of the data frame within the channel occupation duration of the terminal that wins the primary contention. The reason is that subsequent primary contention may not normally be performed in all the channels when the terminal that wins the secondary contention occupies the channel by exceeding the channel occupation duration of the terminal that wins the primary contention. Therefore, terminals that perform the secondary contention and the terminal that wins the secondary contention result set their own channel occupation durations to coincide with a termination time of the channel occupation duration of the terminal that wins the primary contention. That is, the terminals that participate in the secondary contention sets their own channel occupation durations to coincide with the termination time of the channel occupation duration acquired from the data frame of the terminal that wins the primary contention, makes the channel occupation duration information be in the RTS frame, and transmits the RTS frame. The terminal that wins the secondary contention sets their own channel occupation durations to coincide with the termination time of the channel occupation duration acquired from the data frame of the terminal that wins the primary contention, makes the channel occupation duration information be in the data frame, and transmits the data frame. Other terminals that verify a channel occupation duration of a corresponding channel from the RTS frame, the CTS frame, and the data frame transmitted by the terminal that wins the secondary contention do not use the corresponding channel during this duration.

The terminal that transmits the data frame returns to step 510 to perform the primary contention again when transmission is completed (that is, when the ACK frame is received) (565).

According to the result of the secondary contention (555), terminals that are incapable of winding the secondary contention wait until occupation of the channels ends (550) and when the occupation of the channel ends, the terminals return to step 510 to perform the primary contention again.

However, in another exemplary embodiment, according to the result of the secondary contention (555), terminals that are incapable of winning the secondary contention acquires the occupation channel information from the terminal that wins the secondary contention, verify the occupiable channel based on the acquired occupation channel information, and may perform tertiary contention in the occupiable channel. Of course, contention balances of tertiary or more are valid. However, the contention balances may be limited in advance.

As described below, the secondary contention may be performed in the manner a little different from the primary contention in order to reduce the time required for the secondary contention. A scheme for reducing the time required for the secondary contention includes schemes described below.

First, a back-off time generated in the secondary contention is shorter than the back-off time generated in the primary contention. To this end, a back-off unit time of the back-off process, for example, a slot time allocated per one slot constituting the contention window may be shorter than a slot time in the primary contention. Alternatively, the size of the contention window during the back-off process (that is, the number of slots) may be shorter than the size of the contention window in the primary contention. Both the two methods may be applied.

Second, the channel occupation information is included in only the data frame, not the RTS frame and the CTS frame, during the secondary contention. Therefore, since the transmission time of the RTS frame and the CTS frame decreases, the time required for the secondary contention decreases.

Third, according to the result of performing the back-off process and the CCA without performing the RTS/CTS process in the secondary contention, when it is verified that the channel is in the idle state, a signal to notify channel occupation is transmitted and thereafter, the data frame is transmitted. The signal may be a short signal-tone. When the terminals that participate in the secondary contention receive the signal, the terminals recognize that they themselves are incapable of winning the secondary contention and wait until the channel occupation ends.

Meanwhile, in a wireless network environment, the terminal according to the exemplary embodiments of the present invention and an existing legacy terminal may coexist. In this case, the back-off time generated during the secondary contention may be the same as the back-off time generated in the primary contention. The signal to notify the channel occupation is transmitted for a time longer than the back-off unit time, that is, the slot time to notify that the channel occupation occur for the back-off time.

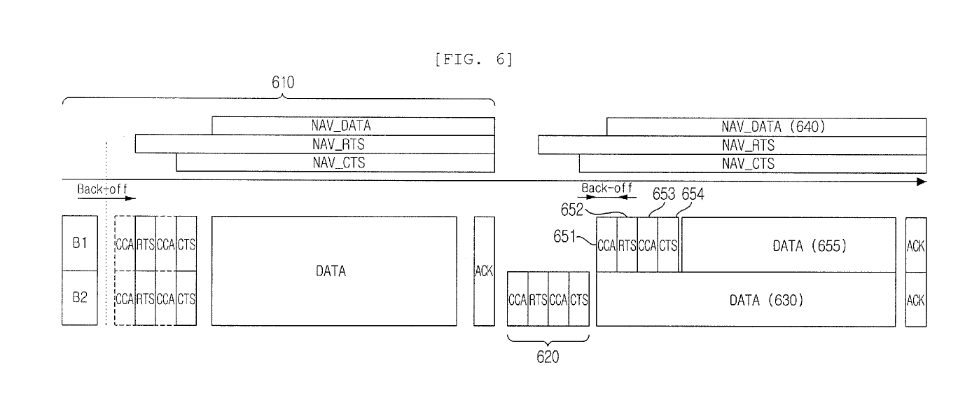

FIG. 6 illustrates one example of a format in which a plurality of terminals occupies channels according to at least one exemplary embodiment of the present invention.

In FIG. 6, since a process corresponding to reference numeral 610 is the same as the process corresponding to reference numeral 310 of FIG. 3, a description thereof will be omitted.

The process corresponding to reference numeral 610 is completed and the terminal A transmits a data frame 630 by using the channel B2 as the terminal B through the primary contention 620.

The terminal A makes occupation channel information B2 and channel occupation duration information 640 be included in a frame header of the data frame 630. Therefore, terminals C, D, E, and F recognize that a band occupied by the terminal A is the channel B2 from the data frame 630. Accordingly, the terminal C that intends to transmit data to the terminal D and the terminal E that intends to transmit data to the terminal F verify the channel B1 as the occupiable channel and perform the secondary contention in the channel B1. Herein, a start time of the secondary contention may coincide with a transmission start time of the data frame 630, that is, a start time of NAV_DATA 640. The time to perform the secondary contention is within a channel occupation duration of the terminal A, that is, the NAV_DATA 640.

FIG. 6 illustrates a case in which the terminal C wins the secondary contention. The terminal C performs the short back-off process and CCA 651 with respect to the channel B1 during the secondary contention, and transmits an RTS frame 652 to the terminal D. The terminal D that receives the RTS frame 652 performs CCA 653 with respect to the channel B1, and transmits a CTS frame 654. The terminal C that receives the CTS frame 654 transmits a data frame 655.

The terminal C that wins the secondary contention sets its own channel occupation duration to coincide with the termination time of the NAV_DATA 640 acquired from the data frame of the terminal A. The channel occupation duration information set as above is included in the RTS frame 652 and the data frame 655. The terminals C and D complete transmission/reception of the data frame within the set channel occupation duration.

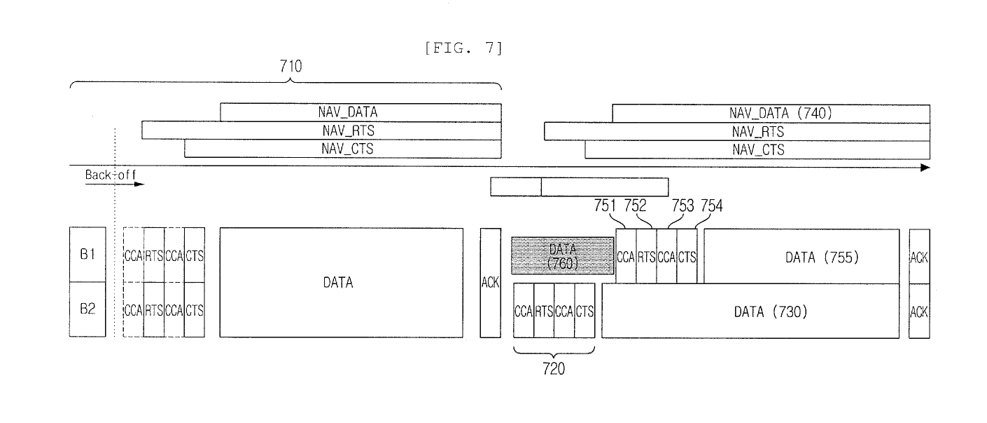

FIG. 7 illustrates another example of a format in which a plurality of terminals occupies channels according to at least one exemplary embodiment of the present invention. In FIG. 7, since a process corresponding to reference numeral 710 is the same as the process corresponding to reference numeral 310 of FIG. 3, a description thereof will be omitted.

In FIG. 7, similarly as the case of FIG. 6, the process corresponding to reference numeral 710 is completed and the terminal A transmits a data frame 730 by using the channel B2 as the terminal B through primary contention 720.

Similarly as the case of FIG. 6, the terminal A makes occupation channel information B2 and channel occupation duration information 740 be included in a frame header of the data frame 730. Therefore, terminals C, D, E, and F recognize that a band occupied by the terminal A is the channel B2 from the data frame 730. Accordingly, the terminal C that intends to transmit data to the terminal D and the terminal E that intends to transmit data to the terminal F verify the channel B1 as the occupiable channel and perform the secondary contention in the channel B1.

However, it is verified that the channel B1 is not in the idle state due to data 760 which has been already transmitted or interference while the terminals C and E perform the secondary contention. Therefore, the terminals that perform the secondary contention may perform a plurality of back-off processes. If the secondary contention allowance time remains, the terminal C may perform CCA 751 and transmit an RTS frame 752 to the terminal D when the B1 band is usable. The terminal D that receives the RTS frame 752 performs CCA 753 with respect to the channel B1, and transmits a CTS frame 754. The terminal C that receives the CTS frame 754 transmits a data frame 755.

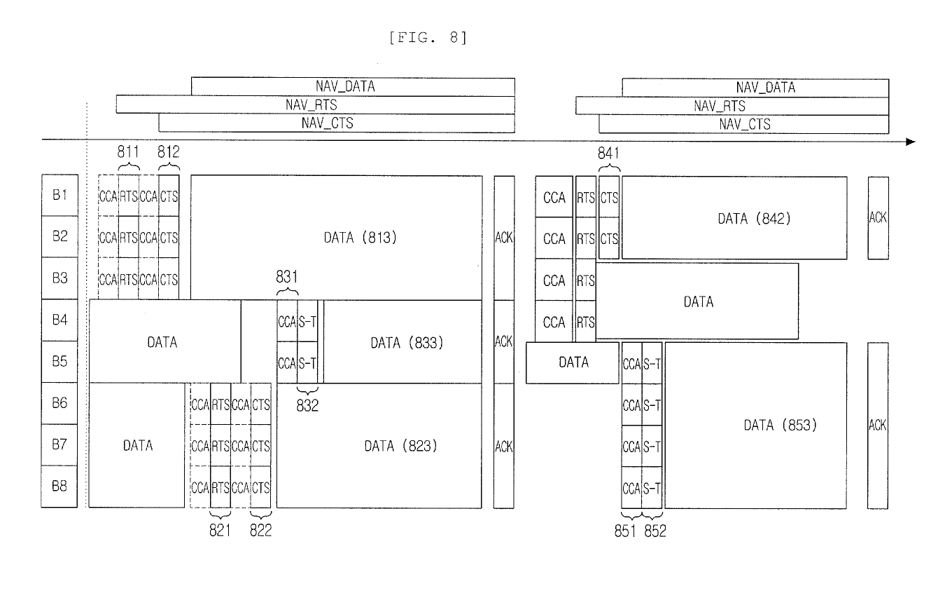

FIG. 8 illustrates yet another example of a format in which a plurality of terminals occupies channels according to at least one exemplary embodiment of the present invention. FIG. 8 is an example of a case in which two or more bands where channel are combinable are configured. In this case, when the terminals intend to occupy the channels through the secondary contention, the occupiable channels may depend on a distribution of empty channels and a channel combination scheme.

Referring to FIG. 8, the terminal A transmits an RTS frame 811 and receives a CTS frame 812 to win the primary contention in the channels B1 to B3, and transmits a data frame 813 to the terminal B through a channel acquired by combining the channels B1 to B3.

The terminal C transmits the RTS frame 821 and receives the CTS frame 822 to win the secondary contention in the channels B6 to B8, and transmits the data frame 823 to the terminal D through a channel acquired by combining the channels B6 to B8.

The terminal E verifies that the channel is in the idle state by performing CCA 831 and transmits a signal-tone 832 to win the tertiary contention in the channels B4 and B5, and transmits a data frame 833 to the terminal F through a channel acquired by combining the channels B4 and B5.

The terminal A receives the CTS frame 841 to win the primary contention in the channels B1 and B2 through the primary contention, and transmits the data frame 842 to the terminal B through the channel acquired by combining the channels B1 and B2.

The terminal C verifies that the channel is in the idle state by performing CCA 851 and transmits a signal-tone 852 to win the secondary contention in the channels B5 to B8, and transmits a data frame 853 to the terminal D through a channel acquired by combining the channels B5 to B8.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A contention based channel occupying method in a wireless network using a plurality of channels, comprising:
acquiring, by terminals that are incapable of transmitting a data frame through primary contention, occupation channel information from a terminal that transmits the data frame through the primary contention;
verifying, by the terminals, an occupiable channel based on the occupation channel information; and
performing, by the terminals, secondary contention in the occupiable channel.

2. The contention based channel occupying method of claim 1, wherein:
in the acquiring of the occupation channel information, the terminals acquire channel occupation duration information from the terminal that transmits the data frame, and
the terminal that transmits the data frame through the secondary contention among the terminals set its own channel occupation duration to coincide with a termination time of a channel occupation duration of the terminal.

3. The contention based channel occupying method of claim 2, wherein:
The terminal that transmits the data frame through the secondary contention makes the set channel occupation duration information be included in the data frame.

4. The contention based channel occupying method of claim 1, wherein:
in the performing of the secondary contention, the terminals start the secondary contention when the data frame is transmitted through the primary contention.

5. The contention based channel occupying method of claim 1, wherein:
in the performing of the secondary contention, each of the terminals set predetermined secondary contention allowance time, and when the secondary contention allowance time is exceeded, each terminal does not perform the secondary contention any more.

6. The contention based channel occupying method of claim 1, wherein:
a back-off unit time of a back-off process for the secondary contention is shorter than a back-off unit time of a back-off process for the primary contention.

7. The contention based channel occupying method of claim 1, wherein:
the size of a contention window of the back-off process for the secondary contention is smaller than the size of the contention window of the back-off process for the primary contention.

8. The contention based channel occupying method of claim 1, wherein:
The terminal that transmits the data frame through the secondary contention among the terminals transmits a signal to notify channel occupation before transmitting the data frame.

9. A contention based channel occupying method in a wireless LAN environment using a plurality of channels, comprising:
acquiring, by terminals that are incapable of transmitting a data frame through primary contention, occupation channel information and a network allocation vector (NAV) from a terminal that transmits the data frame through the primary contention;
verifying, by the terminals, an occupiable channel based on the occupation channel information;
performing, by the terminals, secondary contention in the occupiable channel; and
setting, by a terminal that transmits the data frame, its own NAV to coincide with a termination time of the acquired NAV in accordance with the result of the secondary contention and transmitting the data frame including the set NAV.

10. The contention based channel occupying method of claim 9, wherein:
The primary contention or secondary contention includes back-off, clear channel assessment (CCA), request to send (RTS), and clear to send (CTS).

11. The contention based channel occupying method of claim 9, wherein:
The primary contention or secondary contention includes the back-off and the clear channel assessment (CCA).

12. The contention based channel occupying method of claim 9, wherein:
in the acquiring of the occupation channel information and the NAV, the NAV is extracted from a frame header of the data frame transmitted from the terminal.

13. The contention based channel occupying method of claim 9, wherein:
a slot time of a contention window of the back-off process for the secondary contention is shorter than the slot time of the contention window of the back-off process for the primary contention.

14. The contention based channel occupying method of claim 9, wherein:
the number of slots of the contention window of the back-off process for the secondary contention is shorter than the number of slots of the contention window of the back-off process for the primary contention.

15. The contention based channel occupying method of claim 9, wherein:
when the secondary contention includes the back-off and the clear channel assessment (CCA), not the request to send (RTS) and the clear to send (CTS), the terminal that transmits the data frame through the secondary contention transmits a signal to notify channel occupation before transmitting the data frame.
